(19) United States
(12) Patent Application Publication
(10) Pub. No.: US 2020/0173195 A1
(43) Pub. Date: Jun. 4, 2020

(54) DRIVING DEVICE FOR UNLOCKING AND LOCKING A LOCK

(71) Applicant: Artur Litwinski, Warszawa (PL)

(72) Inventor: Artur Litwinski, Warszawa (PL)

(21) Appl. No.: 16/617,299

(22) PCT Filed: May 29, 2018
(86) PCT No.: PCT/IB2018/053803

§ 371 Date: Nov. 26, 2019

(30) Foreign Application Priority Data
May 31, 2017 (PL) P421767

(51) Int. Cl. E05B 47/02; H04W 4/80; E05B 47/00

(52) U.S. Cl. CPC E05B 47/02; H04W 4/80; E05B 47/0012; E05B 2047/0094; E05B 2047/0058; E05B 2047/0084; E05B 2047/002

(57) ABSTRACT

Apparatus for unlocking and locking a lock (1′) enabling access to protected areas. The apparatus comprising a housing (5) with a housing interior (16). A rotatable shaft (18) with an axis (20). The rotatable shaft (18) is in fixed non-rotatable connection with the housing (5) and is in operative coaxial connection with a rotatable member (6) that is rotatable within a body (4) of the lock (1′) about the axis (20) to change the lock (1′) between the locked condition and the unlocked condition. The housing (5) and the shaft (18) are in operatively supported connection with the body (4) of the lock (1′). A motor (22) extends in the housing interior (16), is in operative connection with the shaft (18), and is operative to cause rotation of the shaft (18) within the body (4) of the lock (1′).

### TECHNICAL FIELD

The exemplary embodiments concern a driving device for unlocking and locking a lock enabling access to protected areas, and in particular to so called “intelligent locks”, the unlocking or locking of which may be effected without the authorized person directly contacting the lock.

### BACKGROUND

From Polish application P.336314, a driving device for a lock is known. The driving device, fixed on the door in a form of a plate fitting, for the motor-driven and manual actuation of a locking cylinder, has a drive shaft for transmitting rotation to the locking cylinder, a knob for manually turning the drive shaft, and a gear motor arranged in the knob for the motor-driven rotation of the drive shaft. A driving toothed wheel is seated on the drive shaft non-rotatably and is connected with the knob such that it transmits torque. The gear motor is coupled to the plate fitting non-rotatably and to the driving toothed wheel by means of a clutch when current is applied.

From German patent application DE102014009826A1 a device for unlocking and locking entrances to access-protected areas is known. The device has a cylindrical housing. The housing encloses a base plate, miniature motor, preferably a direct current motor, electric battery, blocking assembly and control unit. The blocking element of the blocking assembly is a rod with a ring, the rod moved by an electric motor via a torsion spring capable to transmit motion from the motor to the rod. The electric battery is to provide power supply to the control system irrespective of power supplied to the device via an external power supply line. The control unit is controlled via a wireless connection.

### Discussion

The objective of some exemplary embodiments is to develop a new driving device for unlocking and locking a lock, being of simple design, and to provide a new solution type.

The exemplary driving device of some exemplary embodiments for unlocking and locking a lock enabling access to protected areas comprises a driving assembly including a source of electric current, an electric motor and a gear assembly terminating in a toothed gear, arranged in a rotary housing. The exemplary lock has a body, in which a control element of the lock is seated rotatably. The exemplary driving device is arranged such that the housing is seated in a bearing in the body of the lock by means of a control element, to which the housing is connected in a fixed manner, and the driving device is fitted with a ring with teeth to cooperate with the toothed wheel of the driving assembly, the toothed wheel is seated in a bearing rotatably with respect to the housing. The exemplary ring is placed coaxially with the rotary housing and in a fixed manner with respect to the body of the lock.

In exemplary embodiments, the teeth of the ring are inner teeth.

In alternative exemplary embodiments, the teeth of the ring are outer teeth.

In exemplary embodiments, the housing is connected to the control element by means of a shaped releasable connection.

In alternative exemplary embodiments, the housing together with the control element are monolithic.

In exemplary embodiments, the ring is connected with the body of the lock by means of a screw.

In alternative exemplary embodiments, the ring is connected with the body of the lock by means of a shaped connection.

In alternative exemplary embodiments, the ring is seated in a bearing in the rotary housing.

In exemplary embodiments, the driving device is fitted with an electronic control unit to control the driving assembly.

In exemplary embodiments, the electronic control unit is fitted with a first sensor and a manual control button cooperating therewith, arranged on the frontal part of the driving device.

In exemplary embodiments, the electronic control unit is fitted with a second sensor which establishes angular position of the rotary housing.

In exemplary embodiments, the second sensor is an accelerometer (gravity sensor).

In exemplary embodiments, the electronic control unit is controlled wirelessly.

In alternative exemplary embodiments, the electronic control unit is controlled wirelessly by means of computer software, preferably a mobile device application, via a wireless connection.

In alternative exemplary embodiments, the electronic control unit is controlled wirelessly via a Bluetooth wireless connection.

In exemplary embodiments, the electronic control unit is fitted with a micro USB socket intended to deliver supply voltage and to transfer data.

In exemplary embodiments, the driving device is fitted with an electric energy source in a form of a primary or secondary cell.

In exemplary embodiments, the driving device is arranged at the inner side of an entrance to access-protected areas and on the opposite side to the key-controlled part of the lock.

### BRIEF DESCRIPTION OF DRAWINGS

FIG. 1 shows a longitudinal cross-section of an exemplary driving device for unlocking and locking a lock, in an exemplary embodiment with a ring having outer teeth.

FIG. 2 shows a longitudinal cross-section of an exemplary driving device for unlocking and locking a lock, in an alternative exemplary embodiment with a ring having inner teeth.

### DETAILED DESCRIPTION

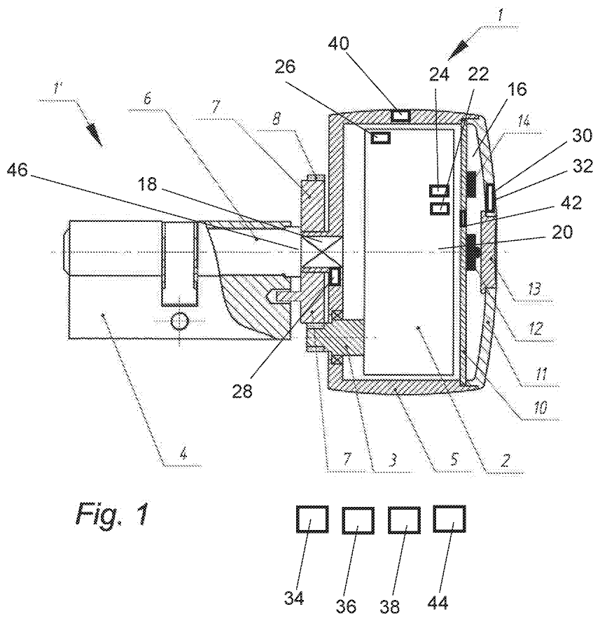

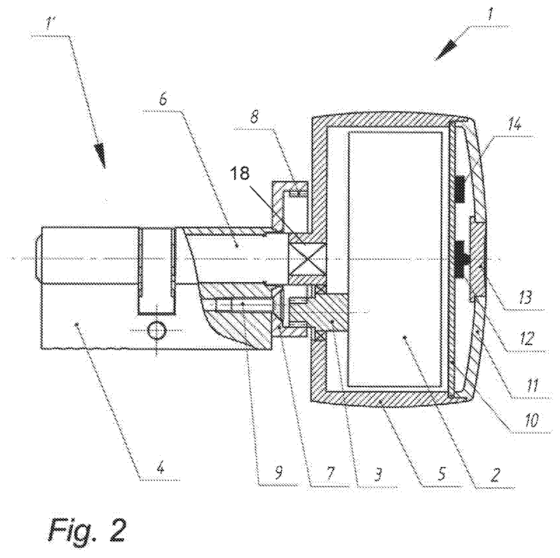

As shown in the exemplary embodiments in FIG. 1 and FIG. 2, an exemplary driving device 1 for unlocking and locking a lock 1′ is shown. The exemplary lock 1′ enables access to protected areas and comprises a driving assembly 2 arranged within a rotary housing 5. The exemplary lock 1′ has a body 4, in which a control element 6, also referred to as a rotatable member, of the lock 1′ is rotatably seated. The exemplary housing 5 is connected in a fixed manner to the control element 6 and is seated in a bearing in a body 4 of the lock 1′ by means of a control element 6.

Alternative exemplary embodiments concern an apparatus operative to selectively change a 1′ between a locked condition and an unlocked condition. The apparatus comprises a housing 5 that includes a housing interior 16. A rotatable shaft 18 that includes an axis 20. The shaft 18 is in fixed non-rotatable operative connection with a housing 5 and is in operative coaxial connection with a rotatable member 6 within the body 4 of the lock 1′. The rotatable member 6 is rotatable within the body 4 of the lock 1′ to change the lock between the locked condition and the unlocked condition. The housing 5 and the shaft 18 are in operatively supported connection with the body 4 of the lock 1′. A motor 22 extends in the housing interior 16, is in operative connection with the shaft 18, and is operative to cause rotation of the shaft 18 within the body 4 of the lock 1′. The exemplary embodiments may include features of Applicant's published application PCT/IB2018/053802 which is incorporated herein by reference in its entirety.

The exemplary housing 5 is configured to be manually engageable such that the shaft 18 is rotatable without operation of the motor 22 through manual rotation of the housing 5. The exemplary driving assembly 2, arranged within the housing 5, usually comprises an electric driving motor, a reduction toothed gear assembly, also referred to as at least one gear 24, and an energy source in the form of an electric cell, also referred to as a battery cell 26. It may also be fitted with a clutch. The structure of the driving assembly 2, being irrelevant to the concept of the invention, is not shown in detail in FIG. 1 or FIG. 2.

In exemplary embodiments, a battery cell 26 extends in the housing interior 16. The exemplary battery cell 26 is in operative electrical connection with the motor 22.

As shown in the exemplary embodiments in FIG. 1 and FIG. 2, the exemplary at least one gear of the driving assembly 2 is fitted with a toothed wheel 3, also referred to as a pinion, which is rotatably seated in a bearing with respect to the housing 5. In exemplary embodiments, the at least one gear is in operative connection with the motor 22 and the housing 5. Operation of the exemplary motor 22 is operative to cause rotation of the at least one gear 24, the housing 5, and the shaft 18.

In alternative exemplary embodiments, the at least one gear 24 is movable between a first position and a second position. In the exemplary first position, the at least one gear 24 is operative to transmit rotational motion between the motor 22 and shaft 18. In the exemplary second position, the at least one gear 24 is not operative to transmit rotational motion between the motor 22 and the shaft 18.

As shown in FIG. 1 and FIG. 2, the exemplary housing 5 is connected to the control element 6 by means of a shaped releasable connection coupling. In alternative exemplary embodiments, a releasable coupling 46 is provided. The exemplary releasable couplings releasably connect the shaft 18 and the rotatable member 6. It is clear that in other exemplary embodiments, the housing 5 may be connected to the control element 6 in another known way which provides a fixed connection of the housing 5 to the control element 6. In some exemplary embodiments, the exemplary housing 5 together with the control element 6 may be monolithic.

The exemplary driving device 1 is fitted with a ring 7, also referred to as a drive ring, with teeth 8 to cooperate with the toothed wheel (pinion) 3 of the at least one gear 24 of the driving assembly 2. The exemplary ring 7 is placed coaxially with the rotary housing 5 and in a fixed manner with respect to the body 4 of the lock 1′. In exemplary embodiments, the drive ring 7 is in rotationally fixed operative connection with the lock 1′. In such embodiments, the shaft 18 and the housing 5 are rotatable relative to the drive ring 7. Further, the pinion 3 is in operative connection with the motor 22, is rotatable relative to the housing 5, and is rotationally movable in operative engagement with the drive ring 7 such that rotational movement of the pinion 3 in engagement with the drive ring 7 causes rotation of the housing 5 and the shaft 18.

In the exemplary embodiment shown in FIG. 1, the exemplary teeth 8 of the ring 7 are outer teeth that extend radially outward.

In alternative exemplary embodiments, the exemplary ring 7 is seated in a bearing in the housing 5 and connected to the body 4 of the lock 1′ by means of a shaped connection.

In the alternative exemplary embodiment shown in FIG. 2, the teeth 8 of the ring 7 are inner teeth that extend radially inward and the ring 7 is connected to the body 4 of the lock 1′ by means of a screw 9.

It is clear that in other exemplary embodiments, the ring 7 may be connected to the body 4 of the lock 1′ in another known way which provides a fixed connection of the ring 7 to the body 4 of the lock 1, for example by means of rivets and glueing. In a specific case, the ring 7 together with the body 4 of the lock 1′ may be monolithic.

As shown in the exemplary embodiments in FIG. 1 and FIG. 2, the exemplary driving device 1 is fitted with an electronic control unit 10, also referred to as control circuitry, which controls the driving assembly 2. The exemplary electronic control unit 10 is arranged within the housing 5, between the driving assembly 2 and the frontal part 11.The exemplary control circuitry 10 is in operative connection with the motor 22, and is operative to selectively operate the motor 22 to cause rotation of the shaft 18.

The exemplary control circuitry 10 is in operative connection with at least one sensor 28. In an exemplary arrangement a first sensor 12, is placed in the central part of the electronic control unit 10. The exemplary first sensor 12 cooperates with a manual control button 13 arranged on the frontal part 11 of the driving device 1 and enables manual actuation of unlocking or locking of the door. The exemplary manual control button 13 is in operative supported connection with the housing 5, is configured to be manually operable, and is operative to cause the control circuitry 10 to cause operation of the motor 22.

The exemplary electronic control unit 10 is also fitted with a second sensor 14 which establishes angular position of the rotary housing 5. The second sensor 14, in the exemplary embodiments shown in FIG. 1 and FIG. 2, is an accelerometer (a sensor that establishes angular position of the rotary housing with respect to the gravitational field of the Earth) and is arranged on the electronic control unit 10.

The exemplary at least one sensor 28 is operative to sense at least one parameter corresponding to a rotational position of the shaft 18. The exemplary sensor 28 is usable to sense if the lock 1′ is in the locked condition or the unlocked condition. The at least one parameter may correspond to operation of the manual control button 13 or the angular position of the housing 5, or both concurrently. For example, the at least one sensor 28 is in operative connection with the housing and the at least one parameter includes a rotational orientation of the housing.

The at least one sensor 28 is in operative connection with the control circuitry 10. In exemplary embodiments, the control circuitry 10 is operative to selectively operate the motor 22 to cause rotation of the shaft 18 to change the lock 1′ between the locked condition and the unlocked condition responsive at least in part to the at least one parameter.

In exemplary embodiments, the electronic control unit 10 is controlled wirelessly by means of computer software, for example, a mobile device application, via a wireless connection. In exemplary embodiments, a transceiver 40 is in operative connection with the control circuitry 10. The exemplary transceiver 40 is operative to wirelessly communicate with a mobile device such as a mobile computer 36 or a mobile phone 38. In such embodiments, the control circuitry 10 is operative to cause operation of the motor 22 responsive at least in part to receipt of at least one signal from the mobile device. For example, the exemplary electronic unit 10 may be controlled wirelessly via a Bluetooth wireless connection. In alternative exemplary embodiments, the transceiver 40 is operative to transmit further signals to the mobile device which may include data corresponding to the at least one parameter.

In alternative exemplary embodiments, the control circuitry 10 further includes a memory 42. The exemplary memory 42 is operative to store data corresponding to the locked and unlocked condition of the lock 1′. In such embodiments, the further signal sent by the transceiver 40 to the mobile device includes the data stored in the memory 42.

The exemplary electronic control unit 10 is fitted with an electric socket 30 that is configured to be operatively connected to an electrical power source 34. The exemplary electric socket 30 is usable to charge the battery cell 26. In exemplary embodiments, the electric socket 30 comprises a micro USB port to deliver supply voltage and to transfer data. In such embodiments, the USB port is in operative connection with the control circuitry 10 and is configured to receive a USB drive 44. The exemplary control circuitry 10 is operative to cause the data stored in the memory 42 to be transferred to the USB drive 44.

The exemplary driving device 1 is fitted with an electric energy source in the form of a primary or secondary battery cell 26.

The exemplary driving device 1 is arranged at the inner side of an entrance to access-protected areas and on the opposite side to the key-controlled part of the lock 1′.

In exemplary embodiments, pressing the exemplary manual control button 13 causes unlocking of the locked lock 1′ or locking of the unlocked lock 1′, which in some exemplary embodiments, is done with a delay. The exemplary second sensor 14 transmits information on the position of the housing 5 to the electronic control unit 10 and to the mobile device of the person controlling the driving device 1, whereby the person has information on unlocking or locking of the lock 1′.

In exemplary embodiments of the driving device 1 for unlocking and locking the lock 1′, the exemplary housing 5 is connected in a rigid (fixed) manner to a control element 6, with the control element 6 being seated in a bearing in the body of the lock 1′. In this exemplary embodiment, the control element 6 of the lock 1′ transmits both the torque from the driving mechanism 2 and the transverse and axial forces, which is why any other bearing of the housing 5 of the driving device 1 with respect to the body 4 of the lock 1′ is unnecessary. The only bearing of the housing 5 of the driving device 1 is the control element 6 of the lock 1′, which provides the idea of the driving device 1 of the exemplary embodiments.

Thus, the elements, features, and characteristics of the exemplary embodiments described achieve desirable results, eliminate difficulties encountered in the use of the prior art devices and systems, solve problems, and attain one or more useful objectives as described herein.

In the foregoing description, certain terms have been used for brevity, clarity, and understanding. However, no unnecessary limitations are to be implied therefrom because such terms are used for descriptive purposes and are intended to be broadly construed. Moreover, the descriptions and illustrations given herein are by way of examples and the useful features are not limited to the exact details shown and described.

Further, in the description, words that refer to left/right, top/bottom, up/down or similar terms indicating relative locations of items shall not be deemed limiting and it is to be understood that exemplary embodiments can be configured and used in numerous different orientations.

Having described the features, discoveries, and principles of the exemplary embodiments, the manner in which they are constructed, operated and utilized, and the advantages and useful results attained, the new and useful structures, devices, elements, arrangements, parts, combinations, systems, equipment, operations, methods, processes and relationships are set forth in the appended claims.

1-18. (canceled)

19. Apparatus operative to selectively change a lock between a locked condition and an unlocked condition, comprising:
a housing, wherein the housing includes a housing interior,
a rotatable shaft, wherein the shaft
includes an axis, and
is in fixed non-rotatable operative connection with the housing,
wherein the shaft is in operative coaxial connection with a rotatable member within a body of the lock, wherein the rotatable member is rotatable within the body of the lock about the axis to change the lock between the locked condition and the unlocked condition,
wherein the housing and the shaft are in operatively supported connection with the body of the lock,
a motor, wherein the motor
extends in the housing interior,
is in operative connection with the shaft, and
is operative to cause rotation of the shaft within the body of the lock.

20. The apparatus according to claim 19
wherein the housing is configured to be manually engageable,
wherein the shaft is rotatable without operation of the motor through manual rotation of the housing.

21. The apparatus according to claim 20 and further comprising:
a battery cell, wherein the battery cell extends in the housing interior and is in operative electrical connection with the motor.

22. The apparatus according to claim 21 and further comprising:
at least one sensor, wherein the at least one sensor is operative to sense at least one parameter corresponding to a rotational position of the shaft, and
wherein the at least one sensor is usable to sense if the lock is in the locked condition or the unlocked condition.

23. The apparatus according to claim 22
wherein the at least one sensor is in operative connection with the housing, wherein the at least one parameter includes a rotational orientation of the housing.

24. The apparatus according to claim 22 and further comprising:
control circuitry, wherein the control circuitry is in operative connection with the motor, and wherein the control circuitry is operative to selectively operate the motor to cause rotation of the shaft.

25. The apparatus according to claim 24
wherein the at least one sensor is in operative connection with the control circuitry,
wherein responsive at least in part to the at least one parameter, the control circuitry is operative to selectively operate the motor to cause rotation of the shaft to change the lock between the locked condition and the unlocked condition.

26. The apparatus according to claim 25 and further comprising:
a manual control button, wherein the control button
is in operative supported connection with the housing,
is configured to be manually operable, and
is operative to cause the control circuitry to cause operation of the motor.

27. The apparatus according to claim 26
wherein the housing includes an electric socket, wherein the electric socket is configured to be operatively connected to an electric power source, wherein the electric socket is usable to charge the battery cell.

28. The apparatus according to claim 27
wherein the electric socket comprises a USB port.

29. The apparatus according to claim 28
and further comprising:
a transceiver, wherein the transceiver is in operative connection with the control circuitry, wherein the transceiver is operative to wirelessly communicate with at least one of
a mobile computer, or
a mobile phone,
wherein the control circuitry is operative to cause operation of the motor responsive at least in part to receipt of at least one signal from the at least one mobile computer or mobile phone.

30. The apparatus according to claim 29
wherein the transceiver is operative to transmit a further signal to the at least one mobile computer or mobile phone, wherein the further signal includes data corresponding to the at least one parameter.

31. The apparatus according to claim 30
wherein the control circuitry further includes a memory, wherein the memory is operative to store data corresponding to the locked and unlocked condition of the lock, and wherein the further signal includes the data stored in the memory.

32. The apparatus according to claim 31
wherein the USB port is
in operative connection with the control circuitry, and
is configured to receive a USB drive,
wherein the control circuitry is operative to cause the data stored in the memory to be transferred to the USB drive.

33. The apparatus according to claim 32 and further comprising:
a releasable coupling, wherein the shaft is operatively connected to the rotatable member through the releasable coupling.

34. The apparatus according to claim 33 and further comprising:
at least one gear,
wherein the at least one gear is in operative connection with the motor and the housing, and wherein operation of the motor is operative to cause rotation of the at least one gear, the housing, and the shaft.

35. The apparatus according to claim 34
and further comprising:
a drive ring, wherein the drive ring is in rotationally fixed operative connection with the lock, and
wherein the shaft and the housing are rotatable relative to the drive ring,
wherein the at least one gear includes a pinion, wherein the pinion
is in operative connection with the motor,
is rotatable relative to the housing, and
is rotationally movable in operative engagement with the drive ring,
wherein rotational movement of the pinion in engagement with the drive ring causes rotation of the housing and the shaft.

36. The apparatus according to claim 35
wherein the at least one gear is movable between a first position and a second position,
wherein in the first position, the at least one gear is operative to transmit rotational motion between the motor and the shaft,
wherein in the second position, the at least one gear is not operative to transmit rotational motion between the motor and the shaft.

37. The apparatus according to claim 36
wherein the drive ring includes either
radially inward extending teeth, wherein the pinion is movable in operative engagement with the drive ring internally of the drive ring, or
radially outward extending teeth, wherein the pinion is movable in operative engagement with drive ring externally of the drive ring.

38. The apparatus according to claim 36
wherein the drive ring is operatively configured to be positioned either
externally of the housing, wherein the pinion is movable in operative engagement with the drive ring outside of the housing, or
internally of the housing, wherein the pinion is movable in operative engagement with the drive ring within the housing.

39. The apparatus according to claim 1 and further comprising:
at least one gear,
wherein the at least one gear is in operative connection with the motor and the housing, and wherein operation of the motor is operative to cause rotation of the at least one gear, the housing, and the shaft.

40. The apparatus according to claim 39
and further comprising:
a drive ring, wherein the drive ring is in rotationally fixed operative connection with the lock, and
wherein the shaft and the housing are rotatable relative to the drive ring,
wherein the at least one gear includes a pinion, wherein the pinion
is in operative connection with the motor,
is rotatable relative to the housing, and
is rotationally movable in operative engagement with the drive ring,
wherein rotational movement of the pinion in engagement with the drive ring causes rotation of the housing and the shaft.

41. Apparatus operative to selectively change a lock between a locked condition and an unlocked condition, comprising:
a housing,
a rotatable shaft, wherein the shaft
includes an axis,
is in fixed operative connection with the housing,
is in operative supported connection within the lock, and
is rotatable about the axis,
a motor, wherein the motor
is in operative connection with the housing, and
is operative to cause
rotation of the housing, and
rotation of the shaft within the lock.
